(19) United States
(12) Patent Application Publication
(10) Pub. No.: US 2013/0331092 A1
(43) Pub. Date: Dec. 12, 2013

(54) DEVICES FOR DETERMINING WHETHER TO SCAN FOR CELLULAR SERVICE

(71) Applicant: Atsushi Ishii, Vancouver, WA (US)

(72) Inventor: Atsushi Ishii, Vancouver, WA (US)

(73) Assignee: Sharp Laboratories of America, Inc., Camas, WA (US)

(21) Appl. No.: 13/491,351

(22) Filed: Jun. 7, 2012

(51) Int. Cl. H04W 24/00; H04W 88/06

(52) U.S. Cl. 455/426.1; 455/456.4; 455/434

(57) ABSTRACT

A wireless communication device for determining whether to scan for cellular service is described. The wireless communication device includes a processor and memory in electronic communication with the processor. Executable instructions are stored in the memory. The wireless communication device obtains a location of the wireless communication device. The wireless communication device also obtains a distance between the wireless communication device and a cellular service area. The wireless communication device also determines whether the distance is less than a threshold. The wireless communication device additionally avoids scanning for cellular service if the distance is not less than the threshold.

### TECHNICAL FIELD

The present disclosure relates generally to communication systems. More specifically, the present disclosure relates to devices for determining whether to scan for cellular service.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may communicate with wireless communication devices.

As wireless communication devices have advanced, improvements in communication capacity, speed, flexibility and/or efficiency have been sought. However, improving communication capacity, speed, flexibility and/or efficiency may present certain problems.

For example, after cellular service is lost, a device may scan for satellite service and camp on the satellite service. The device may scan for cellular service while it is camping on the satellite service. However, continuous scanning for cellular service may consume the device's processing power and battery power. As illustrated in this discussion, systems and methods that conserve processing power and reduce battery consumption may be beneficial.

### BRIEF DESCRIPTION OF THE DRAWINGS

FIG. 1 is a block diagram illustrating one configuration of a wireless communication device in which systems and methods for determining whether to scan for cellular service may be implemented;

FIG. 2 is a flow diagram illustrating one configuration of a method for determining whether to scan for cellular service by a wireless communication device;

FIG. 3 is a block diagram illustrating another configuration of a wireless communication device in which systems and methods for determining whether to scan for cellular service may be implemented;

FIG. 4 is a flow diagram illustrating another configuration of a method for determining whether to scan for cellular service by a wireless communication device;

FIG. 5 is a block diagram illustrating a configuration of a wireless communication device and a computing device in which systems and methods for determining whether to scan for cellular service may be implemented;

FIG. 6 is a flow diagram illustrating another configuration of a method for determining whether to scan for cellular service by a wireless communication device;

FIG. 7 is a flow diagram illustrating one configuration of a method for determining whether to scan for cellular service by a computing device;

FIG. 8 illustrates various components that may be utilized in a wireless communication device;

FIG. 9 illustrates various components that may be utilized in a computing device;

FIG. 10 is a block diagram illustrating one configuration of a wireless communication device in which systems and methods for determining whether to scan for cellular service may be implemented; and

FIG. 11 is a block diagram illustrating one configuration of a computing device in which systems and methods for determining whether to scan for cellular service may be implemented.

### DETAILED DESCRIPTION

The systems and methods disclosed herein may be applied to wireless communication devices with cellular and satellite dual-radio capabilities. For example, when a wireless communication device is outside of a cellular service area, it may communicate via satellite service and determine whether to scan for cellular service. Accordingly, a wireless communication device for determining whether to scan for cellular service is described. The wireless communication device includes a processor and memory in electronic communication with the processor. Executable instructions are stored in the memory. The wireless communication device obtains a location of the wireless communication device. The wireless communication device also obtains a distance between the wireless communication device and a cellular service area. The wireless communication device further determines whether the distance is less than a threshold. The wireless communication device additionally avoids scanning for cellular service if the distance is not less than the threshold.

The wireless communication device may continue to communicate via satellite service if the distance is not less than the threshold. The wireless communication device may obtain a time interval based on the distance and may obtain an updated distance between the wireless communication device and the cellular service area at an expiration of the time interval. The wireless communication device may also determine whether the updated distance is less than the threshold.

The wireless communication device may send the location of the wireless communication device and receive a message indicating a time interval. The location of the wireless communication device may be obtained based on global positioning system (GPS) data.

The wireless communication device may scan for a cellular service if the distance is less than the threshold. The wireless communication device may also connect to the cellular service if the cellular service is discovered and may re-scan for the cellular service after a default period if cellular service is not discovered.

The distance between the wireless communication device and the cellular service area may be obtained based on a cellular service map and global positioning system (GPS) data. Obtaining the distance may include sending the location of the wireless communication device and receiving a message indicating the distance. Determining whether the distance is less than a threshold may include sending the location of the wireless communication device and receiving a message indicating whether the distance is less than the threshold. The wireless communication device may continue to communicate via satellite service if the distance is not less than the threshold.

The cellular service area may be a nearest cellular service area to the wireless communication device. The wireless communication device may obtain a cellular service map.

A method for determining whether to scan for cellular service by a wireless communication device is also described. The method includes obtaining a location of the wireless communication device. The method also includes obtaining a distance between the wireless communication device and a cellular service area. The method further includes determining whether the distance is less than a threshold. The method additionally includes avoiding scanning for cellular service if the distance is not less than the threshold.

A computing device for determining whether to scan for cellular service is also described. The computing device includes a processor and memory in electronic communication with the processor. Executable instructions are stored in the memory. The computing device obtains a location of a wireless communication device. The computing device also obtains a distance between the wireless communication device and a cellular service area. The computing device further determines whether the distance is less than a threshold. The computing device additionally directs the wireless communication device to avoid scanning for cellular service if the distance is not less than the threshold.

The computing device may send a message indicating a time interval. The computing device may send a message indicating that the distance is less than the threshold.

A method for determining whether to scan for cellular service by a computing device is also described. The method includes obtaining a location of a wireless communication device. The method also includes obtaining a distance between the wireless communication device and a cellular service area. The method further includes determining whether the distance is less than a threshold. The method additionally includes directing the wireless communication device to avoid scanning for cellular service if the distance is not less than the threshold.

The systems and methods disclosed herein describe devices for determining whether to scan for cellular service. The term “cellular service area” refers to a geographical area within which a wireless communication device may communicate with a terrestrial cellular network. In some approaches, modern radio frequency technology enables a wireless communication device to support satellite service and cellular service. An example of a satellite service is Enhanced Geostationary Air Link (EGAL). The satellite services, including radio and baseband processors, may be able to coexist with cellular services in wireless communication devices. In such a wireless communication device, because of the air link cost, use of cellular service may take precedence over satellite service. Thus, the use of satellite service may be limited to a situation where a wireless communication device is outside a cellular service area.

In some implementations, outside the cellular service area, the device will scan for, and communicate via, satellite service. However, it is beneficial that the device finds and goes back to the cellular service as soon as possible. In order to do so, the wireless communication device periodically scans for cellular service while it is camping on the satellite service. In the case where the wireless communication device is far from cellular service, the wireless communication device could scan for cellular service, scanning many times for hours of operation without success, which will consume the wireless communication device's processing power and battery power.

The systems and methods disclosed herein describe approaches for saving processing power and reducing battery consumption for wireless communication devices. In some examples, a wireless communication device may use a cellular service map and global positioning system (GPS) data to determine the location of a wireless communication device and to schedule cellular service scans. While a wireless communication device is outside a cellular service area, the distance between the location of the wireless communication device and the nearest cellular service area may be obtained, based on the GPS data and a cellular service map. If the distance is less than a threshold, the wireless communication device may start scanning for cellular service. If the distance is not less than the threshold, an updated location of the wireless communication device and an updated distance may be obtained at the expiration of a time interval. In some approaches, the time interval may be based on the distance. To save power, the wireless communication device may avoid scanning for cellular service before the expiration of the time interval.

In an example, the wireless communication device may store a cellular service map in its non-volatile memory. In some approaches, the cellular service map can be pre-loaded by the wireless communication device manufacturer. In other approaches, the cellular service map can be downloaded from internet servers when the wireless communication device has a non-satellite connection to the internet server. Examples of non-satellite connections include cellular service connection, Wi-Fi connection (e.g., Institute of Electrical and Electronics Engineers (IEEE) 802.11) and Universal Serial Bus (USB) connection.

According to an example, when the wireless communication device is outside of a cellular service area, the device may start scanning for satellite service and may camp on the satellite service. The wireless communication device may start a timer with a pre-determined default period of time. Upon the expiration of the timer, the wireless communication device may obtain a location of the wireless communication device. In some approaches, this may be based on GPS data. The location obtained may be used to determine the distance between the location of the wireless communication device and the nearest cellular service area. If the distance is less than a pre-determined threshold, the wireless communication device may scan for cellular service. If cellular service is discovered, the wireless communication device may deregister from the satellite service and may camp on the cellular service. If cellular service is not discovered, the wireless communication device may continue to communicate via satellite. In some approaches, the wireless communication device may restart the timer with the default period of time in this case.

However, if the distance is greater than the threshold, the wireless communication device may avoid scanning for cellular service. Instead, the wireless communication device may obtain a time interval. In some approaches, the time interval may be based on the distance between the wireless communication device and the cellular service area. For example, the greater the distance, the longer the time interval. In some cases, the time interval may be greater than the default period of time. In some approaches, the time interval may reflect an assumed maximum mobility on the ground. For example, if the distance is 30 miles, the time interval may be no sooner than 30 minutes, assuming that the maximum speed of the wireless communication device is 60 miles per hour.

In some examples, the wireless communication device may communicate with a computing device (e.g., a network server) for the determination of the cellular service area scan and location of the wireless communication device. This allows offloading the on-device computation of the distance and time interval, in addition to eliminating storage of the cellular service map on the wireless communication device. According to some approaches, to obtain the distance, the wireless communication device sends the location to the computing device (e.g., the network server). In some implementations, the wireless communication device may send the location via a satellite service. The computing device, which may be equipped with the cellular service map, may compute the distance and direct the wireless communication device to scan for cellular service if the distance is less than the threshold. If the distance is not less than the threshold, the computing device may send a message to the wireless communication device indicating the time interval.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10 and/or 11). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.”

In 3GPP specifications, a base station is typically referred to as a Node B, an eNB, a home eNB (HeNB) or some other similar terminology. As the scope of the disclosure should not be limited to 3GPP standards, the terms “base station,” “Node B,” “eNB,” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

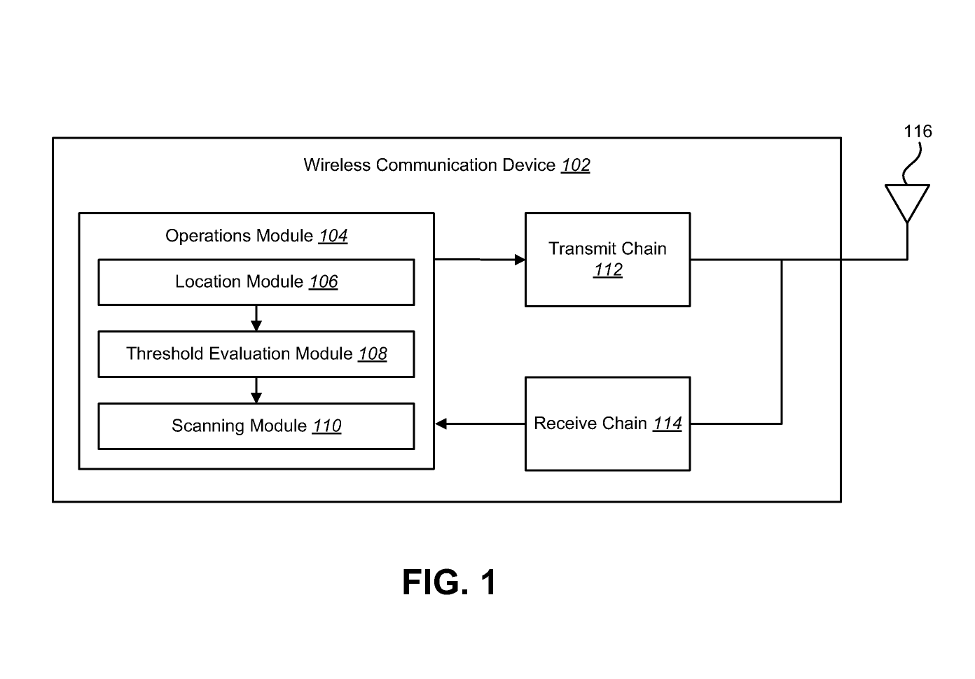

FIG. 1 is a block diagram illustrating one configuration of a wireless communication device 102 in which systems and methods for determining whether to scan for cellular service may be implemented. Examples of wireless communication devices 102 include cellular phones, smart phones, personal digital assistants (PDAs), laptop computers, netbooks, e-readers, wireless modems, etc. In some implementations, the wireless communication device 102 may support multiple wireless communication services. For example, a wireless communication device 102 (e.g., a smart phone) may support cellular service and satellite service. In these implementations, the wireless communication device 102 may alternate between the wireless communication services. For example, the wireless communication device 102 may communicate via cellular service when in a cellular service area. In this example, the wireless communication device 102 may communicate via satellite service when outside a cellular service area.

In some implementations, the wireless communication device 102 may include an operations module 104, a transmit chain 112, a receive chain 114 and one or more antennas 116. As used herein, the term “module” may indicate that a particular element or component may be implemented in hardware, software, firmware or a combination thereof. For example, the operations module 104 may be implemented in hardware (e.g., circuitry), software (e.g., instructions that are executable by a processor) or a combination of both.

The transmit chain 112 may prepare signals (e.g., data and control information) for transmission. For example, the transmit chain 112 may prepare control information supplied by the operations module 104 and provide it to one or more antennas 116 for transmission. The transmit chain 112 may include one or more modules that enable the wireless communication device 102 to transmit signals (e.g., data and control information). In some implementations, for example, the transmit chain 112 may include one or more encoders, one or more scrambling modules, one or more modulation mappers, one or more interleavers, a layer mapper, a pre-coding module, one or more resource element mappers and one or more Orthogonal Frequency-Division Multiplexing (OFDM) signal generation modules.

For instance, the transmit chain 112 may format and transmit signals that include data and control information. For example, the transmit chain 112 may scramble, encode, interleave, modulate, map (to spatial streams or layers), precode, upconvert, filter and amplify (or otherwise format) data and control information for transmission. It should be noted that multiple transmit chains 112 may be included in the wireless communication device 102 in some configurations. The one or more transmit chains 112 may support satellite communications and terrestrial cellular communications.

The receive chain 114 may receive signals from the one or more antennas 116. For example, the receive chain 114 may receive, detect and de-format data and control information from the one or more antennas 116. The receive chain 114 may include one or more modules that enable the wireless communication device 102 to receive signals (e.g., data and control information). In some implementations, for example, the receive chain 114 may include a receive signal detector, one or more demodulators, one or more decoders, one or more deinterleavers and one or more descramblers.

For instance, the receive chain 114 may receive and de-format signals that include data and control information. The receive chain 114 may amplify, downconvert, detect, demodulate, decode, filter and descramble (or otherwise de-format) received signals to produce received data and control information. Received control information may be provided to the operations module 104. It should be noted that multiple receive chains 114 may be included in the wireless communication device 102 in some configurations. The one or more receive chains 114 may support satellite communications and terrestrial cellular communications.

The operations module 104 may enable the wireless communication device 102 to allocate resources for determining whether to scan for cellular service. For example, the operations module 104 may include a location module 106. The location module 106 may allocate resources to obtain the location of the wireless communication device 102. In other words, the location module 106 may obtain the location of the wireless communication device 102. In one example, the location module 106 may utilize GPS data to obtain the location of the wireless communication device 102. For instance, the GPS data may be obtained by a GPS receiver included in the wireless communication device 102. In other words, the wireless communication device 102 may include a GPS receiver that receives signals transmitted by GPS satellites. The GPS receiver may determine the location of the wireless communication device 102 based on receipt times of signals from GPS satellites. Additionally or alternatively, the location module 106 may utilize one or more additional measuring devices (e.g., accelerometers, tilt sensors, etc.) to obtain the location of the wireless communication device 102.

Additionally or alternatively, the location module 106 may obtain the location of the wireless communication device 102 based on user input. For example, a user of the wireless communication device 102 may input the longitude and latitude of the wireless communication device 102.

In some approaches, the location module 106 may be externally connected to the wireless communication device 102. Examples of connections include, but are not limited to a USB connection, Ethernet connection and network connection.

In some implementations, the location module 106 may be connected to a storage device (not shown) that stores the location of the wireless communication device 102. For example, the location module 106 may be connected to a non-volatile memory device that is connected to the wireless communication device 102. In this example, the non-volatile memory device may store the location.

The location module 106 may periodically obtain the location of the wireless communication device 102. Doing so allows the location module 106 to account for movement of the wireless communication device 102. For example, the location module 106 may obtain the location of the wireless communication device 102 at time A. After a period of time, the location module 106 may obtain an updated location of the wireless communication device 102 at time B. In an example, the period of time may be a default time period determined by the wireless communication device 102 manufacturer. In another example, the wireless communication device 102 may obtain the period of time from another computing device. By periodically obtaining the location of the wireless communication device 102, the location module 106 may obtain information relating to distance traveled and velocity of the wireless communication device 102.

In some examples, the location module 106 is connected to a threshold evaluation module 108. In these examples, the location module 106 provides the threshold evaluation module 108 with the location of the wireless communication device 102. The threshold evaluation module 108 may determine whether the distance between the wireless communication device 102 and a cellular service area is less than a threshold. In some examples, the threshold may be based on the likelihood of discovering cellular service. In other examples, the threshold may be based on input. This input may be received from a user of the wireless communication device 102, or may be received from the wireless communication device 102 manufacturer.

In some approaches, the threshold evaluation module 108 may be included in the operations module 104. In other approaches, the threshold evaluation module 108 may be connected to the wireless communication device 102 through an external device that is coupled to the wireless communication device 102. For example, the threshold evaluation module 108 may not be connected directly to the operations module 104, but may be connected to the wireless communication device 102 by communicating with the external device. For instance, the external device may host the threshold evaluation module 108 and may send a message to the wireless communication device 102 indicating a determination of whether the distance is below the threshold. This approach may be beneficial as it allows offloading of the threshold evaluation to the external device and may reduce the processing load on the wireless communication device 102. Additionally, battery power of the wireless communication device 102 may be preserved.

In some configurations, the operations module 104 may include a scanning module 110. The scanning module 110 may be coupled to the threshold evaluation module 108. The scanning module 110 may scan for wireless communication services. For example, if the threshold evaluation module 108 determines that the distance between the wireless communication device 102 and a cellular service area is less than the threshold, the scanning module 110 may scan for cellular service. According to some examples, the scanning module 110 may scan for more than one type of wireless communication services. For example, the scanning module 110 may scan for a cellular service area as well as scanning for a satellite service area. In some approaches, the scanning module 110 may select which types of wireless communication services to scan for. For example, if the distance is less than the threshold, the scanning module 110 may scan for cellular service. By comparison, if the distance is not less than the threshold, the scanning module 110 may scan for satellite service. As another example, the scanning module 110 may select which type of wireless communication service to scan for based on availability of service types. For example, if cellular service is available, the scanning module 110 may avoid scanning for satellite service. By comparison, if cellular service area is not available (e.g., cellular service is lost), the scanning module 110 may scan for satellite service.

It should be noted that one or more of the elements or parts thereof included in the wireless communication device 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

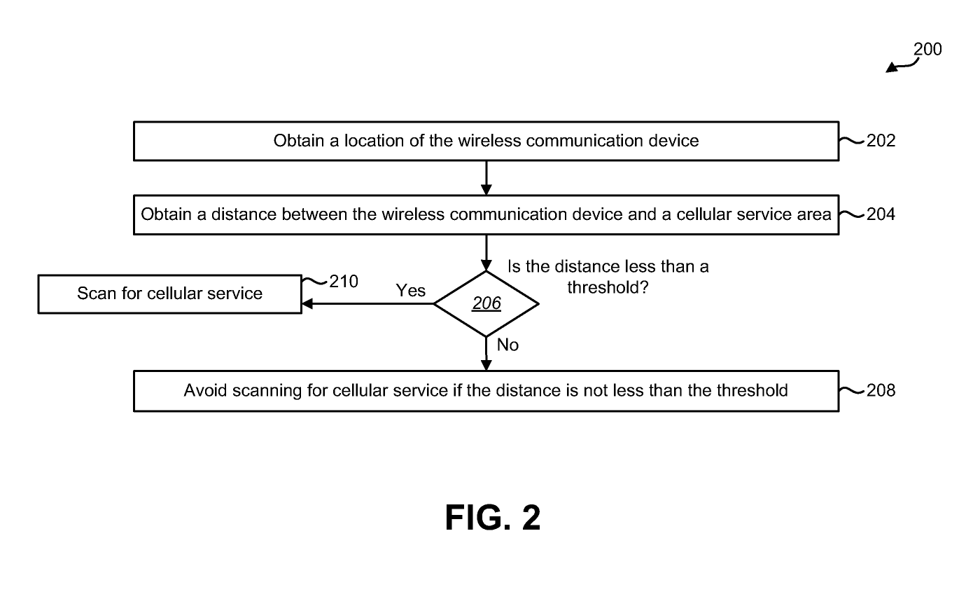

FIG. 2 is a flow diagram illustrating one configuration of a method 200 for determining whether to scan for cellular service by a wireless communication device. In some approaches, the wireless communication device 102 may obtain 202 a location of the wireless communication device 102. In some approaches, the wireless communication device 102 obtains the location from the location module 106 which may be included on the operations module 104 of the wireless communication device 102. For example, the location module 106 may utilize GPS data to determine the location of the wireless communication device 102. For example, the wireless communication device 102 may include a GPS receiver that receives signals transmitted by GPS satellites. The GPS receiver may determine location based on receipt times of signals from GPS satellites.

In some implementations, the wireless communication device 102 may obtain 202 the location from another computing device. For example, the wireless communication device 102 receives the location from the other computing device wireless communication device. For example, the other computing device (e.g., a network server) may host location information for any number of wireless communication devices. In this example, the wireless communication device 102 may receive a message from the other computing device indicating the location of the wireless communication device 102. This computing device may be one example of the external device described above.

In some approaches, the obtained location may be stored to a storage device (not shown) coupled to the wireless communication device 102. For example, the location at time A may be stored and compared to the location at time B. From these locations a distance traveled and velocity may be obtained. In some implementations, the wireless communication device 102 may obtain 202 the location based on additional or alternative approaches (using accelerometers, tilt sensors, etc., for example).

The wireless communication device 102 may obtain 204 a distance between the wireless communication device 102 and a cellular service area. In some implementations, the cellular service area may be the cellular service area nearest the wireless communication device 102. In some approaches, the wireless communication device 102 obtains 204 the distance based on information contained in the operations module 104. For example, as will be described in detail below, the wireless communication device 102 may use GPS data and a cellular service map to determine the distance.

In some approaches, the location module 106 of the wireless communication device 102 obtains the distance from another computing device. In an example, the wireless communication device 102 obtains the location, for example from GPS data, and sends the location to the other computing device. The other computing device may determine the distance based on the location and the wireless communication device 102 may receive a message indicating the distance. In another example, the other computing device may host information indicating the location of the wireless communication device 102 and wireless communication device 102 may receive a message indicating the distance.

With the distance obtained, the threshold evaluation module 108 may determine 206 whether the distance is less than a threshold. In some implementations, the threshold may be determined by the likelihood of discovering cellular service. For example, if the wireless communication device 102 is located where it is unlikely to discover cellular service, the threshold may be greater. By comparison, if the wireless communication device 102 is located where there is a greater likelihood of discovering cellular service, the threshold distance may be smaller. In some implementations, the threshold may be based on input. For example, a user of the wireless communication device 102 may input the desired threshold. In other implementations, the threshold may be based on input from the wireless communication device 102 manufacturer.

According to some implementations, determining 206 whether the distance is less than a threshold may be implemented on another computing device. As described above, in this implementation the wireless communication device 102 may receive a message from the other computing device indicating whether or not the distance is less than the threshold. Offloading this computation to another computing device may be beneficial as it reduces the processing load to the wireless communication device 102 and may therefore save processing power and reduce battery consumption of the wireless communication device 102.

The wireless communication device 102 may avoid 208 scanning for cellular service if the distance is not less than the threshold. Scanning for cellular service utilizes processing power and battery power of the wireless communication device 102. Thus, in some implementations, avoiding 208 scanning for cellular service may be beneficial because it may conserve processing power and reduce battery consumption of the wireless communication device 102. In some implementations, if the distance is less than the threshold, the wireless communication device 302 may scan 210 for cellular service. In this implementation, the wireless communication device 102 may also continue to communicate with another wireless service, for example, a satellite service, if the distance is not less than the threshold.

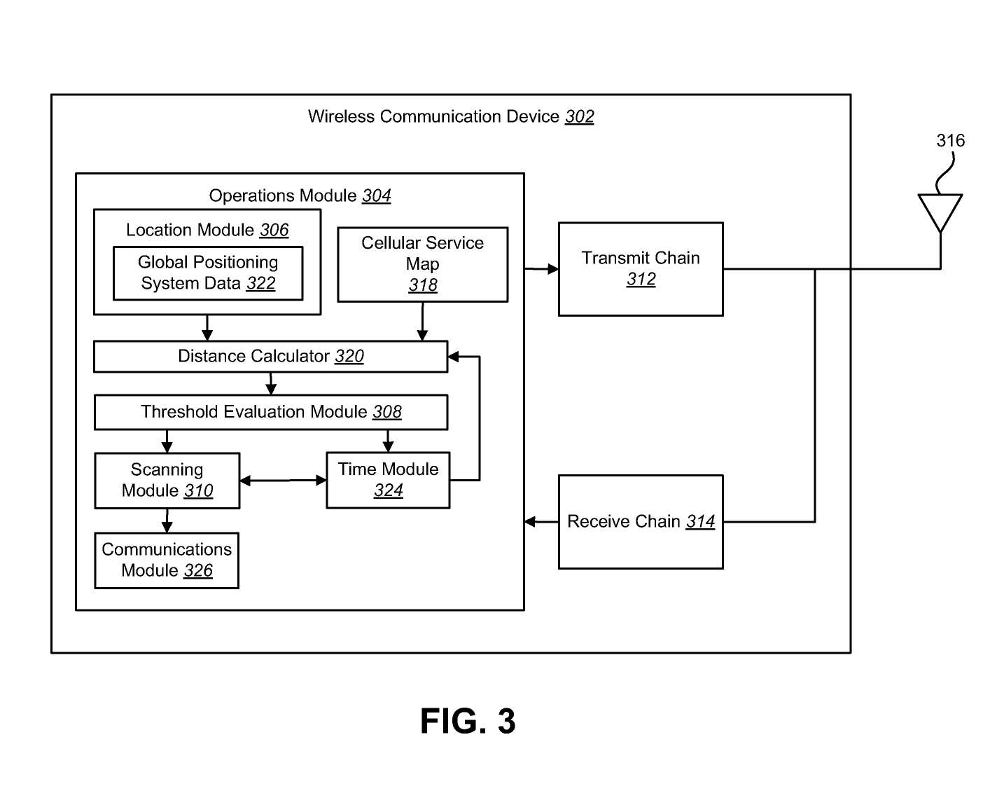

FIG. 3 is a block diagram illustrating another configuration of a wireless communication device 302 in which systems and methods for determining whether to scan for cellular service may be implemented. Examples of wireless communication devices 302 include cellular phones, smart phones, personal digital assistants (PDAs), laptop computers, netbooks, e-readers, wireless modems, etc.

The wireless communication device 302 may be similar to the wireless communication device 102 described previously in connection with FIG. 1. The wireless communication device 302 may include one or more of an operations module 304, a transmit chain 312, a receive chain 314 and one or more antennas 316 similar to corresponding elements described above in connection with FIG. 1. In some implementations, the operations module 304 may include one or more of a location module 306, a threshold evaluation module 308 and a scanning module 310 similar to corresponding elements described in connection with FIG. 1. As used herein, the term “module” may indicate that a particular element or component may be implemented in hardware, software, firmware or a combination thereof. For example, the operations module 304 may be implemented in hardware (e.g., circuitry), software (e.g., instructions that are executable by a processor) or a combination of both.

As described above, the operations module 304 may enable the wireless communication device 302 to allocate resources for determining whether to scan for cellular service. For example, the operations module 304 may include a location module 306. The location module 306 may obtain the location of the wireless communication device 302.

In some approaches, the location module 306 may utilize GPS data 322 to obtain the location of the wireless communication device 302. In some approaches, the GPS data 322 is obtained by the wireless communication device 302. For example, the wireless communication device 302 may include a GPS receiver that receives signals from GPS satellites. The receiver may determine the time to receive those signals and obtain the location of the wireless communication device 302. In some approaches, the location of the wireless communication device 302 may be based on the longitude and latitude of the wireless communication device 302. In other approaches, the location may be based on a point of origin of the wireless communication device 302 and GPS data 322 associated with velocity and direction traveled.

The GPS data 322 may include position information associated with the wireless communication device 302. For example, the GPS data 322 may include one or more of elevation information, distance traveled information and velocity information associated with the wireless communication device 302.

In some implementations, the GPS data 322 may include geographic maps that identify the location of the wireless communication device 302. In some implementations, a portion of the geographic data that is associated with the wireless communication device 302 may be included in the GPS data 322. For example, geographic maps covering a 100-mile radius of the wireless communication device 302 may be included. In some approaches, as the wireless communication device 302 changes location, the geographic maps may be updated to reflect the change in location.

In some examples, the geographic maps may be preloaded onto the wireless communication device 302. In other examples, the geographic maps may be loaded onto the wireless communication device 302 from an external (e.g., remote) device (e.g., they may be downloaded from an internet server).

In some approaches, a portion of the GPS data 322 is included on an external device connected to the wireless communication device 302. Examples of connections include, but are not limited to a USB connection, Ethernet connection and network connection. For example, the external device may include geographic maps associated with the wireless communication device 302. In this example, the wireless communication device 302 may receive location information from the external device.

The operations module 304 may include a cellular service map 318. A cellular service map 318 identifies geographic regions where cellular service is available. In some implementations, the cellular service map 318 may be preloaded onto the wireless communication device 302. In other implementations, the cellular service map 318 may be received. For example, the wireless communication device 302 may receive the cellular service map 318 from an internet server.

In some implementations, a portion of the cellular service map 318 may be included on the wireless communication device 302. For example, the operations module 304 may include a portion of a cellular service map 318 that corresponds to a 100-mile radius around the location of the wireless communication device 302.

The operations module may also include a distance calculator 320. The distance calculator 320 may use the location and the cellular service map 318 to identify the distance between the wireless communication device 302 and a cellular service area. The distance calculator 320 may also store the distance to a storage device coupled to the wireless communication device 302. In some implementations, the distance calculator 320 calculates the distance between the wireless communication device 302 and the cellular service area that is nearest the wireless communication device.

In some implementations, the distance calculator 320 may periodically calculate the distance to reflect changes in the distance. In these implementations, the distance calculator 320 may receive an updated location. The period of time after which the distance calculator 320 recalculates the distance may be based on the GPS data 322 associated with the wireless communication device 302. In one example, if a wireless communication device 302 is located far from a cellular service area, the period may be longer. Alternatively, if a wireless communication device 302 is located close to a cellular service area, the period may be shorter. In another example, if a wireless communication device 302 is located far from a cellular service area, and is moving at a slow rate of speed, the period may be longer. By comparison, if the wireless communication device 302 is close to a cellular service area, and is moving at a fast rate of speed, the period may be shorter. In other examples, the period may be a default period of time established by the wireless communication device 302 manufacturer. The period of time may also be based on input received by the wireless communication device 302.

The operations module 304 may also include a time module 324. In the event that the threshold evaluation module 308 determines that the distance is greater than the threshold, the time module 324 may determine the time interval after which the distance calculator 320 may recalculate the distance between the wireless communication device 302 and a cellular service area. As described previously, the time module 324 may use the distance between the wireless communication device 302 and a cellular service area to determine the time interval after which a new distance may be calculated.

If the distance is less than the threshold, the scanning module 310 may begin scanning for cellular service. In the event that cellular service is not discovered, the time module 324 may determine the period after which a new scan for cellular service may begin. In some implementations, this determination may include instructing the distance calculator 320 to recalculate the distance, and the threshold evaluation module 308 to determine again whether the distance is less than a threshold.

The operations module 304 may also include a communications module 326. In the event that the distance is less than the threshold, and cellular service is discovered, the communications module 326 establishes a communication link and communicates via the cellular service. In some implementations, the communications module 326 may also allow a communication link with a satellite service if cellular service is not discovered.

It should be noted that one or more of the elements or parts thereof included in the wireless communication device 302 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

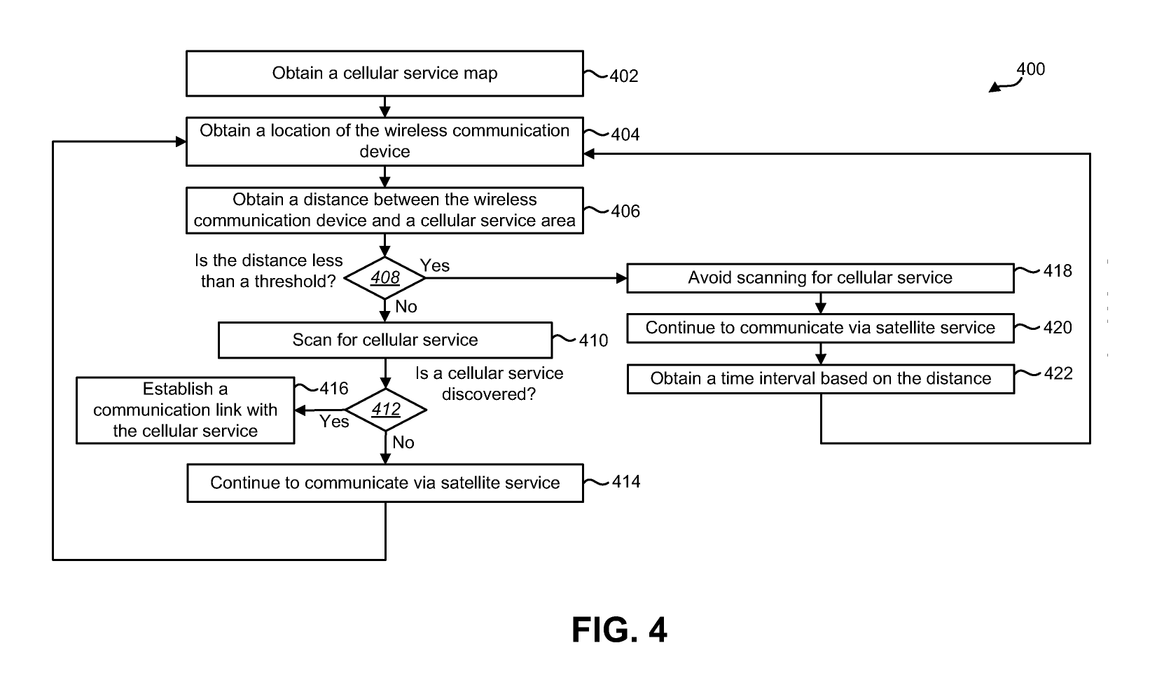

FIG. 4 is a flow diagram illustrating another configuration of a method 400 for determining whether to scan for cellular service by a wireless communication device. In some approaches, the wireless communication device 302 may obtain 402 a cellular service map 318. As described above, a cellular service map 318 identifies geographic regions where cellular service is available. According to some approaches, a cellular service area on a cellular service map may be identified by a longitude and latitude point and a radius. In other approaches, a cellular service area may be identified by shapes (with one or more of center points, edge points, borders, dimensions, orientations, etc., such as hexagons of a particular size, for example) on a cellular service map. In some implementations, the cellular service map 318 may be preloaded onto the wireless communication device 302. In other implementations, the wireless communication device 302 may obtain 402 the cellular service map 318 from another computing device. For example, the wireless communication device may receive the cellular service map 318 from the other computing device through a network (e.g., the internet).

In some implementations, the wireless communication device 302 may obtain a portion of the cellular service map 318. For example, the wireless communication device 302 may download a portion of the cellular service map that pertains to a 100-mile radius around the location of the wireless communication device 302. In certain examples, the cellular service map 318 obtained by the wireless communication device 302 may be updated. For example, as a wireless communication device 302 moves, the 100-mile radius portion of the cellular service map 318 may change. In this example, as the wireless communication device 302 changes location, the cellular service map 318 may be updated to reflect this change. For example, a GPS receiver located within the wireless communication device 302 may indicate that the wireless communication device 302 has changed location. In this case, for instance, the wireless communication device 302 may download an updated portion of the cellular service map 318 that pertains to the updated location of the wireless communication device 318. In some implementations, the wireless communication device 302 may download the updated portion of the cellular service map 318 automatically (e.g., without user input).

The wireless communication device 302 may obtain 404 a location of the wireless communication device 302. In some implementations, this may be done as described in connection with FIG. 2.

The wireless communication device 302 may also obtain 406 a distance between the wireless communication device 302 and a cellular service area. In some implementations, this may be done as described in connection with FIG. 2. As described above, the distance may pertain to a cellular service area that is nearest the wireless communication device 302.

With the distance obtained, the wireless communication device 302 may determine 408 whether the distance is less than a threshold. In some implementations, this may be done as described in connection with FIG. 2.

If the distance is not less than the threshold, the wireless communication device 302 may avoid 418 scanning for cellular service. In some implementations, this may be done as described in connection with FIG. 2. As described above, avoiding scanning for cellular service may be beneficial as it may save processing power and reduce battery consumption of the wireless communication device 302. Additionally, if the distance is not less than the threshold, the wireless communication device 302 may continue 420 to communicate via satellite service.

If the distance is not less than the threshold, the wireless communication device 302 may also obtain 422 a time interval based on the distance. In some implementations, the time interval may be obtained 422 by the time module 324. As described previously, the time interval reflects a period after which the distance calculator 320 may recalculate the distance between the wireless communication device 302 and a cellular service area. In some implementations, the interval is based on the distance. For example, if the distance is larger the time interval may be greater. By comparison, if the distance is smaller, the time interval may be smaller. The time interval may also be based on the rate of change of the location of the wireless communication device 302. For example, if the wireless communication device 302 is moving quickly, the time interval may be smaller. By comparison, if the wireless communication device 302 is moving slowly, the time interval may be larger.

In some implementations, the time interval may be obtained 422 from an external device connected to the wireless communication device 302. In this example, the wireless communication device 302 would receive a message indicating the time interval. Obtaining 422 the time interval from another computing device offloads the computation of the interval from the wireless communication device 302 and may be beneficial as it may conserve processing power and reduce battery consumption of the wireless communication device 302.

If the distance is not less than the threshold, the distance calculator 320 may return to obtaining 404 a location of the wireless communication device at the expiration of the time interval. As the location of the wireless communication device 302 may have changed after the time interval, the distance calculator 320 may obtain an updated distance at the end of the time interval that reflects the change in location. In some cases, the updated distance may correspond to the same cellular service area as calculated previously. However, in other cases, the updated distance may reflect the distance between the wireless communication device and a different cellular service area. For example, the distance may pertain to the distance between the wireless communication device 302 and a cellular service area A. In this example, the updated distance may pertain to the distance between the wireless communication device 302 and a cellular service area B.

Upon determining 408 whether the distance is less than a threshold, if the distance is less than the threshold, the wireless communication device 302 may scan 410 for cellular service. The wireless communication device 302 may determine 412 if cellular service has been discovered. For example, the wireless communication device 302 may determine whether the wireless communication device 302 has detected or received signals from a base station and/or can communicate successfully with the base station. If cellular service is not discovered, the wireless communication device 302 may continue 414 to communicate via satellite service. The wireless communication device 302 may return to obtain 404 a location of the wireless communication device 302. In some implementations, this may occur after a period of time. It should be noted that this period may be different from the time interval. For instance, if cellular service is not discovered, the wireless communication device 302 may continue 414 to communicate via satellite service and may start a timer with a default time period before returning to obtain 404 an updated location of the wireless communication device 302. Operation may then continue as described above. For example, the wireless communication device 302 may re-scan 410 for cellular service if an updated distance (based on an updated location, for example) is less than the threshold.

If cellular service is discovered, the wireless communication device 302 may establish 416 a communication link with the cellular service. In this example, the wireless communication device 302 may also disconnect from another wireless service, for example a satellite service.

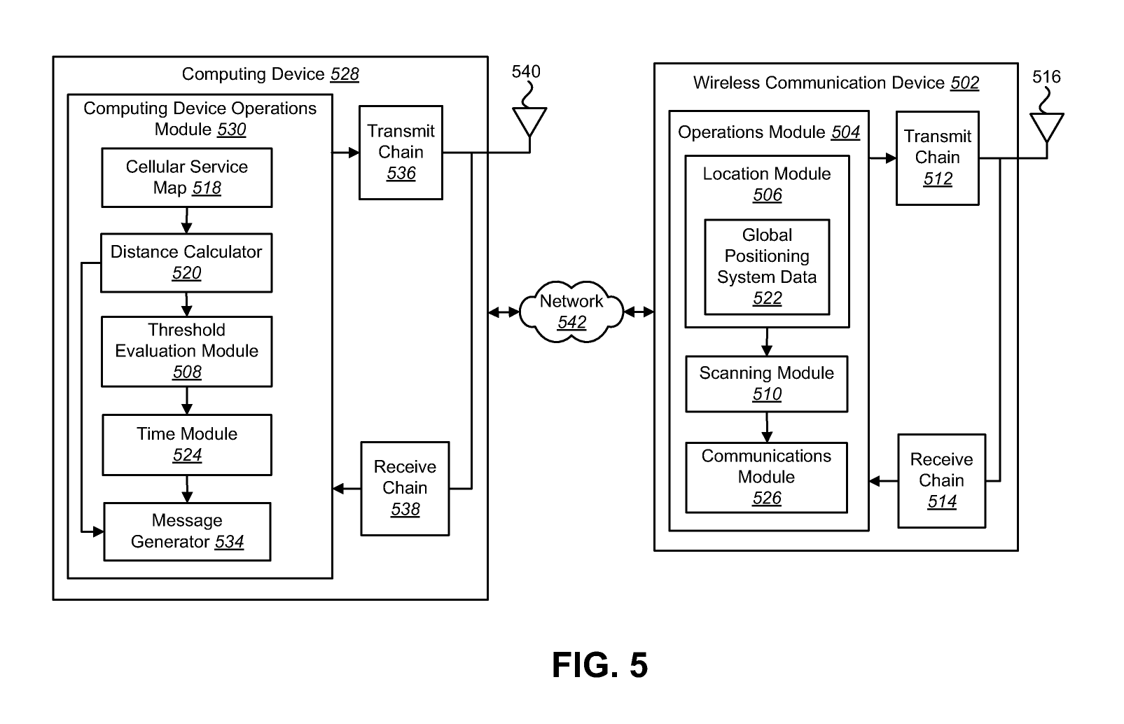

FIG. 5 is a block diagram illustrating a configuration of a wireless communication device 502 and a computing device 528 in which systems and methods for determining whether to scan for cellular service may be implemented. The wireless communication device 502 may include one or more of an operations module 504, a transmit chain 512, a receive chain 514 and one or more antennas 516 similar to corresponding elements described above in connection with FIG. 3. In some implementations, the operations module 504 may include a location module 506, GPS data 522, a scanning module 510 and a communications module 526 similar to corresponding elements described in connection with FIG. 3.

Examples of a computing device 528 include, but are not limited to, desktop computers, laptop computers, servers, supercomputers, tablet devices, cellular phones, smartphones, gaming systems and other computing devices. The computing device 528 may include one or more of a computing device operations module 530, a transmit chain 536, a receive chain 538 and one or more antennas 540 similar to the operations module 304, transmit chain 312, receive chain 314 and one or more antennas 316 described above in connection with FIG. 3. In some implementations, the computing operations module 530 may include a cellular service map 518, a distance calculator 520, a threshold evaluation module 508 and a time module 524 similar to corresponding elements described in connection with FIG. 3. The computing device 528 may be coupled to the wireless communication device 502 through a network 542. Examples of a network 542 include personal area networks, local area networks (LAN), wide area networks (WAN), cellular service areas, satellite service areas and any other type of network.

According to some implementations, the computing device 528 may obtain a location of the wireless communication device 502. In some approaches, the computing device 528 may receive the location from the wireless communication device 502. The computing device 528 may utilize the location to determine the distance. The computing device 528 may additionally or alternatively determine whether the distance is less than a threshold. If the distance is not less than the threshold, the computing device 528 may indicate to the wireless communication device 502 the time interval after which the wireless communication device 502 may obtain an updated location. If the distance is less than the threshold the computing device 528 may direct the wireless communication device 502 to begin scanning for cellular service.

The computing device operations module 530 may include a message generator 534. If the distance is not less than the threshold, the message generator 534 generates a message indicating the time interval after which the wireless communication device 502 should obtain a new location and obtain a new distance. If the distance is less than the threshold, the message generator 534 generates a message directing the wireless communication device 502 to scan for cellular service. In some implementations, the transmit chain 536 of the computing device 528 may send the message generated by the message generator 534 to the receive chain 514 of the wireless communication device 502.

It should be noted that one or more of the elements depicted as included in the computing device 528 and the wireless communication device 502 may be interchanged. For example, the cellular service map 518 included on the computing operations module 530 may be included in the operations module 504 of the wireless communication device 502.

It should be noted that one or more of the elements or parts thereof included in the wireless communication device 502 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

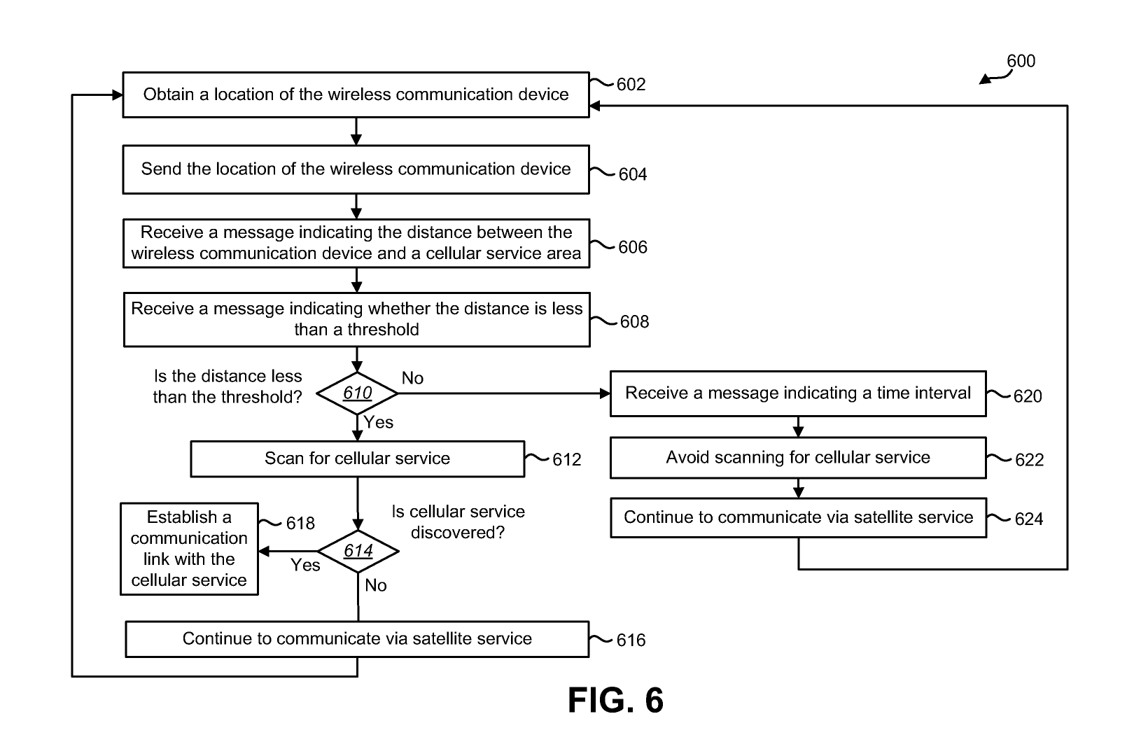

FIG. 6 is a flow diagram illustrating another configuration of a method 600 for determining whether to scan for cellular service by a wireless communication device and a computing device. The wireless communication device 502 may obtain 602 a location of the wireless communication device 502. In some implementations, this may be done as described in connection with FIG. 2.

The wireless communication device 502 may send 604 the location of the wireless communication device 502 to the computing device 528. Sending the location to the computing device 528 offloads the computation of the distance and may be beneficial as it may save processing power and may reduce battery consumption of the wireless communication device 502. The wireless communication device 502 may receive 606 a message indicating the distance. In some implementations, the wireless communication device 502 may also receive 608 a message indicating whether the distance is less than a threshold. These messages may be received from the computing device 528. In some implementations, the messages may be transferred (e.g., sent and received) via the network 542 (e.g., satellite network).

The wireless communication device 502 may determine 610 whether the distance is less than a threshold. If the message indicates that the distance is not less than the threshold, the wireless communication device 502 may receive 620 a message indicating a time interval. As described above, the time interval indicates a period, after which the wireless communication device 502 returns to obtain 602 a location of the wireless communication device 502. According to some implementations, this message is received from the computing device 528.

If the distance is not less than the threshold, the wireless communication device 502 may avoid 622 scanning for cellular service. In some implementations, this may be done as described in connection with FIG. 2. Additionally, if the distance is not less than the threshold, the wireless communication device 502 may continue 624 to communicate via satellite service. In some implementations, this may be done as described in connection with FIG. 4. At the expiration of the time interval, the wireless communication device 502 may return to obtain 602 a location of the wireless communication device 502.

Upon determining 610 whether the distance is less than a threshold, if the distance is less than the threshold, the wireless communication device 502 may scan 612 for cellular service. In some implementations, this may be done as described in connection with FIG. 4. The wireless communication device 502 may determine 614 if cellular service is discovered. If cellular service is not discovered, the wireless communication device 502 may continue 616 to communicate via satellite service. The wireless communication device 502 may return to obtain 602 a location of the wireless communication device 502. In some implementations, this may occur after a default period of time. It should be noted that this default period may be different from the time interval. For instance, if cellular service is not discovered, the wireless communication device 502 may continue 614 to communicate via satellite service and may start a timer with a default time period before returning to obtain 602 an updated location of the wireless communication device 502. Operation may then continue as described above. For example, the wireless communication device 502 may re-scan 612 for cellular service if an updated distance (based on an updated location, for example) is less than the threshold. In other implementations, the wireless communication device 502 may re-scan 612 for cellular service a number of times (with or without one or more periods in between each scan 612) before returning to obtain 602 an updated location and determine 610 whether an updated distance is less than a threshold.

If cellular service is discovered, the wireless communication device 502 may establish 618 a communication link with the cellular service. In this example, the wireless communication device 502 may also disconnect from another wireless service, for example, a satellite service.

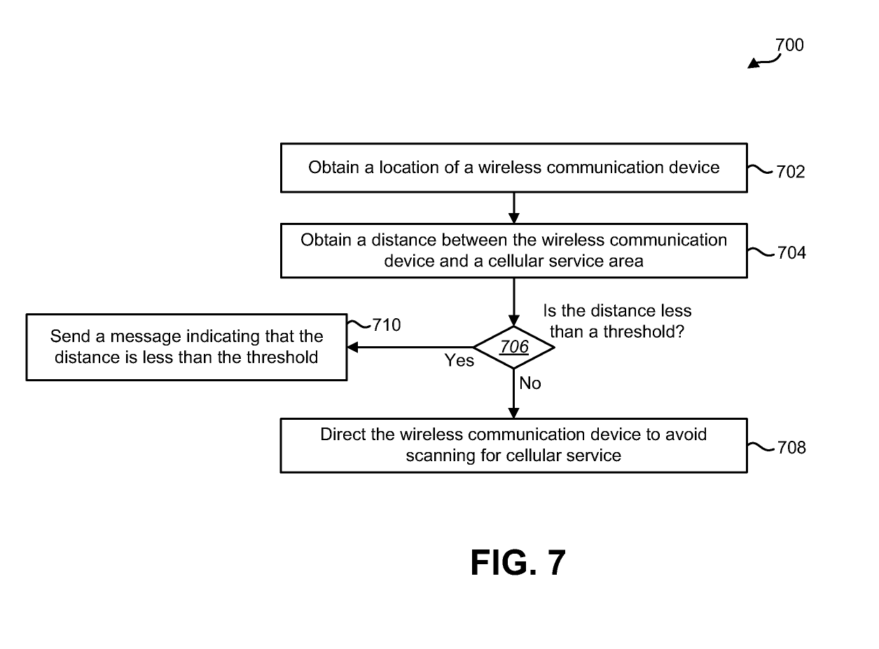

FIG. 7 is a flow diagram illustrating one configuration of a method 700 for determining whether to scan for cellular service by a computing device. In some approaches, the computing device 528 may optionally obtain 702 a location of the wireless communication device 502. In some approaches, the computing device may obtain 702 the location from the wireless communication device 502. For example, the location module 506 may obtain the location and the computing device 528 may receive the location from the wireless communication device 502. In other approaches, the computing device 528 may host location information for the wireless communication device 502. For example, the computing device 528 may obtain 702 a location of the wireless communication device 502 based on data (e.g., received signal strength measurements, directionality measurements, etc.) received from one or more base stations (e.g., cellular phone base stations, Wi-Fi access points, etc.). In some approaches, the obtained 702 location may be stored to a storage device (not shown) coupled to the computing device 528.

Additionally or alternatively, the computing device 528 may obtain 704 a distance between the wireless communication device 502 and a cellular service area. In some implementations, the cellular service area may be the cellular service area nearest the wireless communication device 502. In some implementations, the computing device 528 obtains 704 the distance from the wireless communication device 502, for example, through the distance calculator 320. In other implementations, the computing device 528 may use location information hosted on the computing device and a cellular service map 518 to determine the distance. In some configurations, the computing device 528 may send distance information to the wireless communication device 502 based on the distance obtained 704.

With the distance obtained, the computing device 528 may additionally or alternatively determine 706 whether the distance is less than a threshold. If the distance is not less than a threshold, the computing device 528 may direct 708 the wireless communication device 502 to avoid scanning for cellular service. In some configurations, the computing device 528 may direct 708 the wireless communication device 502 to avoid scanning for cellular service by sending a message indicating that the distance is not less than the threshold. In some implementations, the computing device 528 may also send a message indicating a time interval at the expiration of which the wireless communication device 502 may recalculate the distance. If the distance is less than a threshold, the computing device may send 710 a message indicating that the distance is less than the threshold. In some configurations, this message may direct the wireless communication device 502 to scan for cellular service.

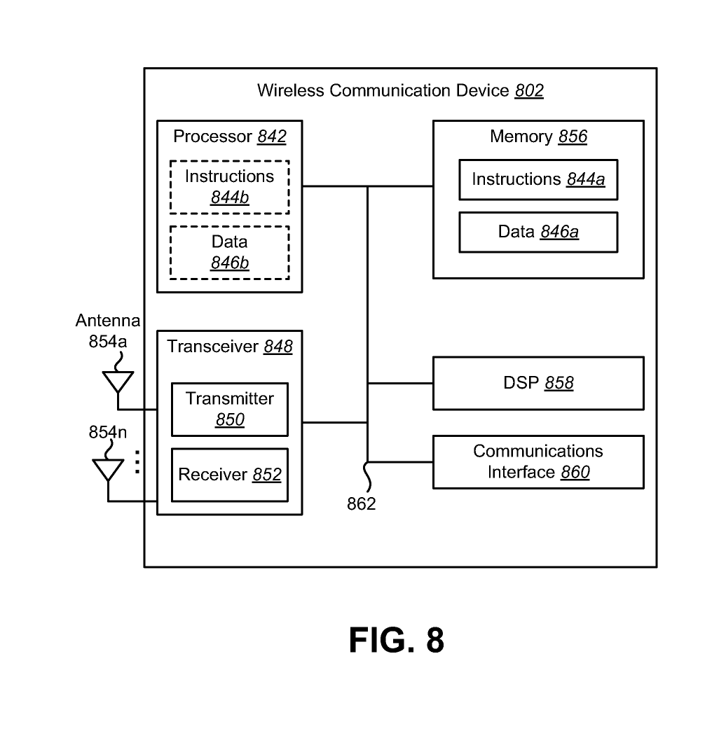

FIG. 8 illustrates various components that may be utilized in a wireless communication device 802. One or more of the wireless communication devices 102, 302 and 502 described herein may be implemented in accordance with the wireless communication device 802 described in connection with FIG. 8. The wireless communication device 802 includes a processor 842 that controls operation of the wireless communication device 802. The processor 842 may also be referred to as a central processing unit (CPU). Memory 856, which may include read-only memory (ROM), random access memory (RAM), a combination of the two or any type of device that may store information, provides instructions 844a and data 846a to the processor 842. A portion of the memory 856 may also include non-volatile random access memory (NVRAM). Instructions 844b and data 846b may also reside in the processor 842. Instructions 844b and/or data 846b loaded into the processor 842 may also include instructions 844a and/or data 846a from memory 856 that are loaded for execution or processing by the processor 842. The instructions 844b may be executed by the processor 842 to implement the one or more of the methods 200, 400, 600, and approaches described above.

The wireless communication device 802 may also include a housing that contains one or more transmitters 850 and one or more receivers 852 to allow transmission and reception of data. The transmitter(s) 850 and receiver(s) 852 may be combined into one or more transceivers 848. One or more antennas 854a-n are attached to the housing and electrically coupled to the transceiver 848.

The various components of the wireless communication device 802 are coupled together by a bus system 862, which may include a power bus, a control signal bus and a status signal bus, in addition to a data bus. However, for the sake of clarity, the various buses are illustrated in FIG. 8 as the bus system 862. The wireless communication device 802 may also include a digital signal processor (DSP) 858 for use in processing signals. The wireless communication device 802 may also include a communications interface 860 that provides user access to the functions of the wireless communication device 802. The wireless communication device 802 illustrated in FIG. 8 is a functional block diagram rather than a listing of specific components.

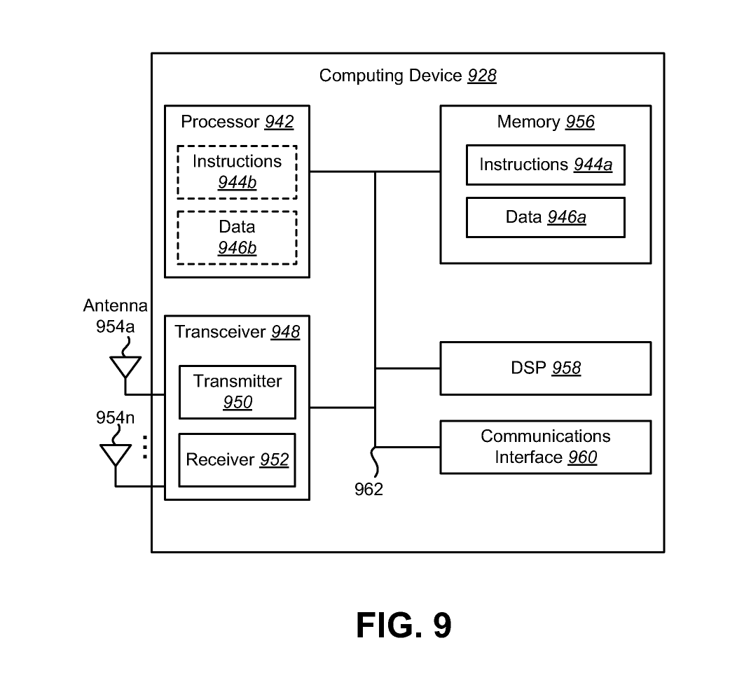

FIG. 9 illustrates various components that may be utilized in a computing device 928. One or more of the computing devices described herein (e.g., computing device 528) may be implemented in accordance with the computing device 928 described in connection with FIG. 9. The computing device 928 includes a processor 942 that controls operation of the computing device 928. The processor 942 may also be referred to as a central processing unit (CPU). Memory 956, which may include read-only memory (ROM), random access memory (RAM), a combination of the two or any type of device that may store information, provides instructions 944a and data 946a to the processor 942. A portion of the memory 956 may also include non-volatile random access memory (NVRAM). Instructions 944b and data 946b may also reside in the processor 942. Instructions 944b and/or data 946b loaded into the processor 942 may also include instructions 944a and/or data 946a from memory 956 that are loaded for execution or processing by the processor 942. The instructions 944b may be executed by the processor 942 to implement the one or more of the methods 700 and approaches described above.

The computing device 928 may also include a housing that contains one or more transmitters 950 and one or more receivers 952 to allow transmission and reception of data. The transmitter(s) 950 and receiver(s) 952 may be combined into one or more transceivers 948. One or more antennas 954a-n are attached to the housing and electrically coupled to the transceiver 948.

The various components of the computing device 928 are coupled together by a bus system 962, which may include a power bus, a control signal bus and a status signal bus, in addition to a data bus. However, for the sake of clarity, the various buses are illustrated in FIG. 9 as the bus system 962. The computing device 928 may also include a digital signal processor (DSP) 958 for use in processing signals. The computing device 928 may also include a communications interface 960 that provides user access to the functions of the computing device 928. The computing device 928 illustrated in FIG. 9 is a functional block diagram rather than a listing of specific components.

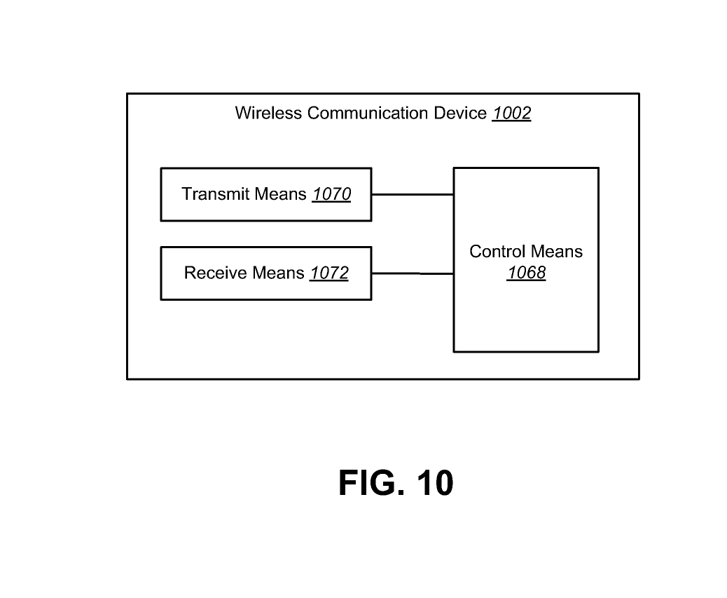

FIG. 10 is a block diagram illustrating one configuration of a wireless communication device 1002 in which systems and methods for determining whether to scan for cellular service may be implemented. The wireless communication device 1002 includes transmit means 1070, receive means 1072 and control means 1068. The transmit means 1070, receive means 1072 and control means 1068 may be configured to perform one or more of the functions described in connection with FIGS. 2, 4, 6 and 7. FIG. 8 above illustrates one example of a concrete apparatus structure of FIG. 10. Other various structures may be implemented to realize one or more of the functions of FIGS. 2, 4, 6 and 7. For example, a DSP may be realized by software.

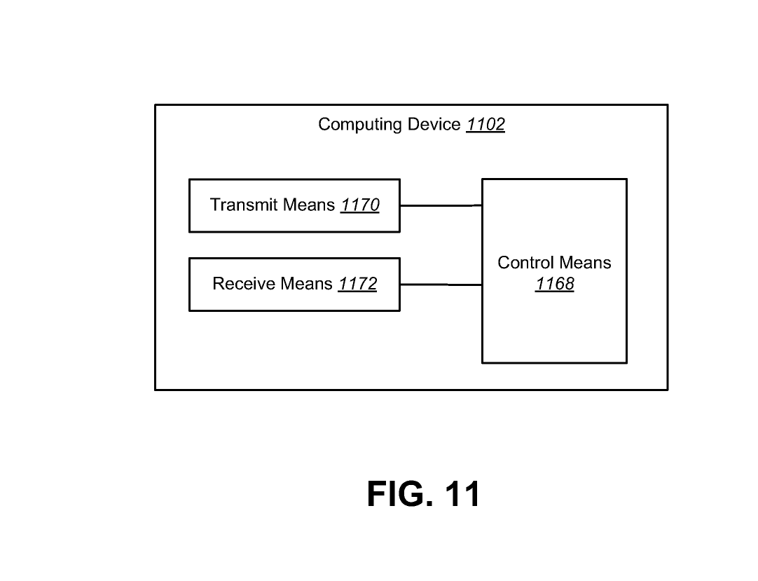

FIG. 11 is a block diagram illustrating one configuration of a computing device 1102 in which systems and methods for determining whether to scan for cellular service may be implemented. The computing device 1102 includes transmit means 1170, receive means 1172 and control means 1168. The transmit means 1170, receive means 1172 and control means 1168 may be configured to perform one or more of the functions described in connection with FIG. 7. FIG. 9 above illustrates one example of a concrete apparatus structure of FIG. 11. Other various structures may be implemented to realize one or more of the functions of FIG. 7. For example, a DSP may be realized by software.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A wireless communication device for determining whether to scan for cellular service comprising:
a processor;
memory in electronic communication with the processor, wherein instructions stored in the memory are executable to:
obtain a location of the wireless communication device;
obtain a distance between the wireless communication device and a cellular service area;
determine whether the distance is less than a threshold; and
avoid scanning for cellular service if the distance is not less than the threshold.

2. The wireless communication device of claim 1, wherein the instructions are further executable to continue to communicate via satellite service if the distance is not less than the threshold.

3. The wireless communication device of claim 1, wherein the instructions are further executable to:
obtain a time interval based on the distance;
obtain an updated distance between the wireless communication device and the cellular service area at an expiration of the time interval; and
determine whether the updated distance is less than the threshold.

4. The wireless communication device of claim 1, wherein the instructions are further executable to:
send the location of the wireless communication device; and
receive a message indicating a time interval.

5. The wireless communication device of claim 1, wherein the instructions are further executable to:
scan for a cellular service if the distance is less than the threshold;
connect to the cellular service if the cellular service is discovered; and
re-scan for the cellular service after a default period if cellular service is not discovered.

6. The wireless communication device of claim 5, wherein the instructions are further executable to continue to communicate via satellite service if the distance is not less than the threshold.

7. The wireless communication device of claim 1, wherein the location of the wireless communication device is obtained based on global positioning system (GPS) data.

8. The wireless communication device of claim 1, wherein the distance between the wireless communication device and the cellular service area is obtained based on a cellular service map and global positioning system (GPS) data.

9. The wireless communication device of claim 1, wherein obtaining the distance comprises:
sending the location of the wireless communication device; and
receiving a message indicating the distance.

10. The wireless communication device of claim 1, wherein determining whether the distance is less than a threshold comprises:
sending the location of the wireless communication device; and
receiving a message indicating whether the distance is less than the threshold.

11. The wireless communication device of claim 1, wherein the cellular service area is a nearest cellular service area to the wireless communication device.

12. The wireless communication device of claim 1, wherein the instructions are further executable to obtain a cellular service map.

13. A method for determining whether to scan for cellular service by a wireless communication device, comprising:
obtaining a location of the wireless communication device;
obtaining a distance between the wireless communication device and a cellular service area;
determining whether the distance is less than a threshold; and
avoiding scanning for cellular service if the distance is not less than the threshold.

14. The method of claim 13, further comprising continuing to communicate via satellite service if the distance is not less than the threshold.

15. The method of claim 13, further comprising:
obtaining a time interval based on the distance;
obtaining an updated distance between the wireless communication device and the cellular service area at an expiration of the time interval; and
determining whether the updated distance is less than the threshold.

16. The method of claim 13, further comprising:
sending the location of the wireless communication device; and
receiving a message indicating a time interval.

17. The method of claim 13, further comprising:
scanning for cellular service if the distance is less than the threshold;
connecting to the cellular service if the cellular service is discovered; and
re-scanning for the cellular service after a default period if the cellular service is not discovered.

18. The method of claim 17, further comprising continuing to communicate via satellite service if the distance is not less than the threshold.

19. The method of claim 13, wherein the location of the wireless communication device is obtained based on global positioning system (GPS) data.

20. The method of claim 13, wherein the distance between the wireless communication device and the cellular service area is obtained based on a cellular service map and global positioning system (GPS) data.

21. The method of claim 13, wherein obtaining the distance comprises:
sending the location of the wireless communication device; and
receiving a message indicating the distance.

22. The method of claim 13, wherein determining whether the distance is less than a threshold comprises:
sending the location of the wireless communication device; and
receiving a message indicating whether the distance is less than the threshold.

23. The method of claim 13, wherein the cellular service area is a nearest cellular service area to the wireless communication device.

24. The method of claim 13, further comprising obtaining a cellular service map.

25. A computing device for determining whether to scan for cellular service comprising:
a processor;
memory in electronic communication with the processor, wherein instructions stored in the memory are executable to:
obtain a location of a wireless communication device;
obtain a distance between the wireless communication device and a cellular service area;
determine whether the distance is less than a threshold; and
direct the wireless communication device to avoid scanning for cellular service if the distance is not less than the threshold.

26. The computing device of claim 25 wherein the instructions are further executable to send a message indicating a time interval.

27. The computing device of claim 25 wherein the instructions are further executable to send a message indicating that the distance is less than the threshold.

28. A method for determining whether to scan for cellular service by a computing device, comprising:
obtaining a location of a wireless communication device;
obtaining a distance between the wireless communication device and a cellular service area;
determining whether the distance is less than a threshold; and
directing the wireless communication device to avoid scanning for cellular service if the distance is not less than the threshold.

29. The method of claim 28 further comprising sending a message indicating a time interval.

30. The method of claim 28 further comprising sending a message indicating that the distance is less than the threshold.
